(19) United States
(12) Patent Application Publication
(10) Pub. No.: US 2011/0226094 A1
(43) Pub. Date: Sep. 22, 2011

(54) FASTENING DEVICE AND METHOD, AS WELL AS DEVICE FOR GENERATING PERCUSSIONS

(75) Inventors: Simon Stahel, Chur (CH); Stefan Bönig, Achberg-Esseratsweiler (DE); Markus Durig, Gaschurn (AT); Markus Frommelt, Schaan (LI)

(73) Assignee: HILTI AKTIENGESELLSCHAFT, Schaan (LI)

(21) Appl. No.: 13/052,202

(22) Filed: Mar. 21, 2011

(30) Foreign Application Priority Data
Mar. 22, 2010 (DE) 10 2010 003 130.5

(51) Int. Cl. B25D 1/00; F16B 21/00; B21D 39/00

(52) U.S. Cl. 81/20; 411/511; 29/509

(57) ABSTRACT

A device and a method for fastening a first object of a second object are provided. The device comprises a sleeve and an arbor, wherein the sleeve comprises a first load application means for the first object and an abutment for an outer surface of the second object, as well as a passage, wherein a contraction of the passage in the sleeve extends at least up to the point of the passage that is the closest adjacent point to the abutment.

### TECHNICAL FIELD

The invention pertains to a device and a method for fastening a first object on a second object, as well as to a device for generating percussions.

### PRIOR ART

Fastening devices frequently comprise a sleeve and an arbor, wherein the sleeve features a first load application means for the first object and a passage. The sleeve is inserted into a drilled hole in the second object. The arbor can be inserted into the passage in order to expand the sleeve in the drilled hole and to thusly achieve a fastening effect. However, a minimum insertion depth of the sleeve into the drilled hole and therefore a minimum depth of the drilled hole need to be ensured in order to achieve satisfactory holding forces.

If the objects are painted or provided with a protective layer, in particular, there also is a risk of damaging the paint or the protective layer.

The invention is based on the objective of making available a device for reliably fastening a first object on a second object. The invention also aims to make available a method for reliably fastening a first object on a second object. The invention furthermore aims to make available a device for carrying out such a method.

### DISCLOSURE OF THE INVENTION

The objective of the invention is attained with a device for fastening a first object on a second object which features a sleeve and an arbor, wherein the sleeve features a first load application means for the first object and an abutment for an outer surface of the second object, as well as a passage, wherein the passage features an insertion section that lies adjacent to the first load application means and an expansion section, wherein the expansion section features a contraction that is smaller than the outside dimensions of the arbor, and wherein the contraction extends at least up to the point of the passage that is the closest adjacent point to the abutment.

One preferred embodiment is characterized in that the contraction increasingly contracts the passage from the point of the passage that is the closest adjacent point to the abutment to the second load application means. It is particularly preferred that the contraction features a conical and/or cylindrical section.

One preferred embodiment is characterized in that the arbor can be inserted into the insertion section in a freely movable fashion.

One preferred embodiment is characterized in that the sleeve features a second load application means for the second object adjacent to the expansion section.

One preferred embodiment is characterized in that the device features a sealing element for realizing a seal between the sleeve and the second object. It is particularly preferred that the sealing element is realized in the form of an O-ring or a molded plastic part.

One preferred embodiment is characterized in that the first load application means features a holding element that, in particular, is positively and/or integrally fixed on the sleeve. It is particularly preferred that the holding element is arranged such that it is freely rotatable relative to the sleeve about an axis and realized such that it has an asymmetric cross section perpendicular to said axis.

The objective of the invention is also attained with a method for fastening a first object on a second object, in which a) the second object is provided with a recess, b) a sleeve with a first load application means for the first object, with an abutment for an outer surface of the second object, and with a passage is inserted into the recess, wherein the passage features an insertion section that lies adjacent to the first load application means and an expansion section, c) an arbor is inserted into the insertion section, wherein the expansion section features a contraction that is smaller than the outside dimensions of the arbor, and d) the arbor is driven into the expansion section such that the region of the sleeve inserted into the recess is expanded against the recess. Step d) is carried out, in particular, with the same tool that was used previously for carrying out step a).

The objective of the invention is also attained with a device for generating percussions on a fastening element which features a supporting means for supporting the device on a housing of a drill in a rotationally rigid fashion, a power take-off means for tapping a rotational movement of a rotatively driven drill chuck of the drill, a striking element for transmitting percussions to the fastening element and a striking mechanism for converting a rotational movement of the power take-off means into a linear movement of the striking element. The device preferably features a receptacle for the fastening element.

One preferred embodiment is characterized in that the device features, in particular, a step-down gear that is connected to the power take-off means on the input side and to the striking mechanism on the output side.

One preferred embodiment is characterized in that the striking mechanism features a force detecting means for detecting a contact force of the fastening element on a surface, as well as coupling means that disengage the power transmission from the power take-off means to the striking element as long as the contact force of the fastening element on the surface is lower than a predetermined force and engage the power transmission from the power take-off means to the striking element when the contact force of the fastening element on the surface is at least as high as the predetermined force.

### EMBODIMENTS

Embodiments of the invention are described in greater detail below with reference to the drawings. In these drawings:

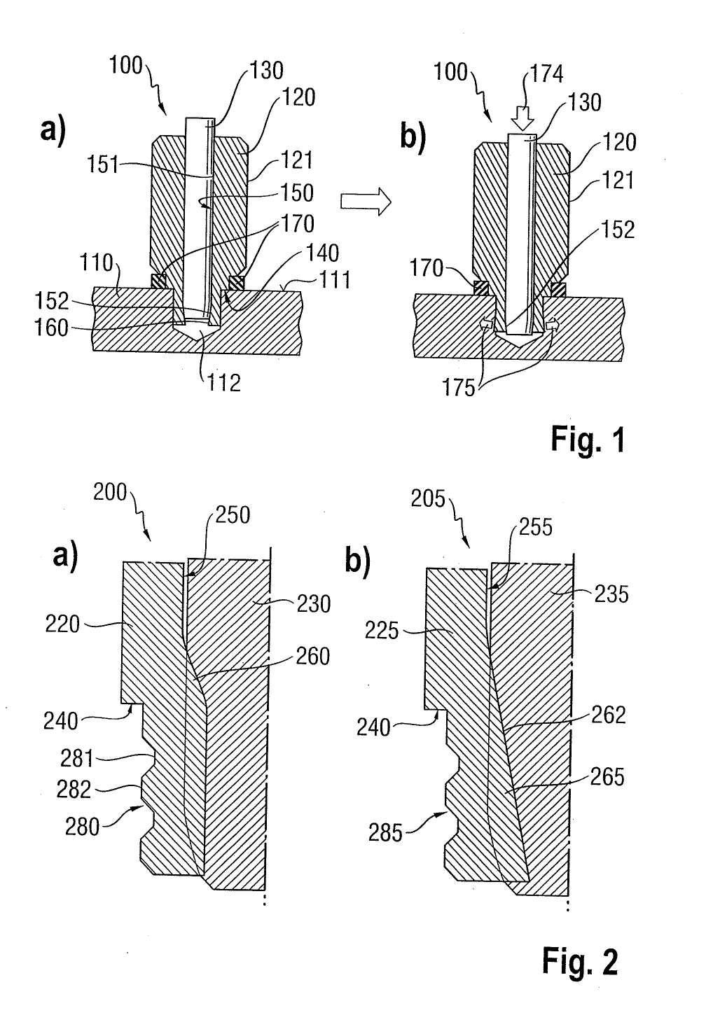

FIG. 1 shows a fastening device in cross section,

FIG. 2 shows a detail of a fastening device in cross section,

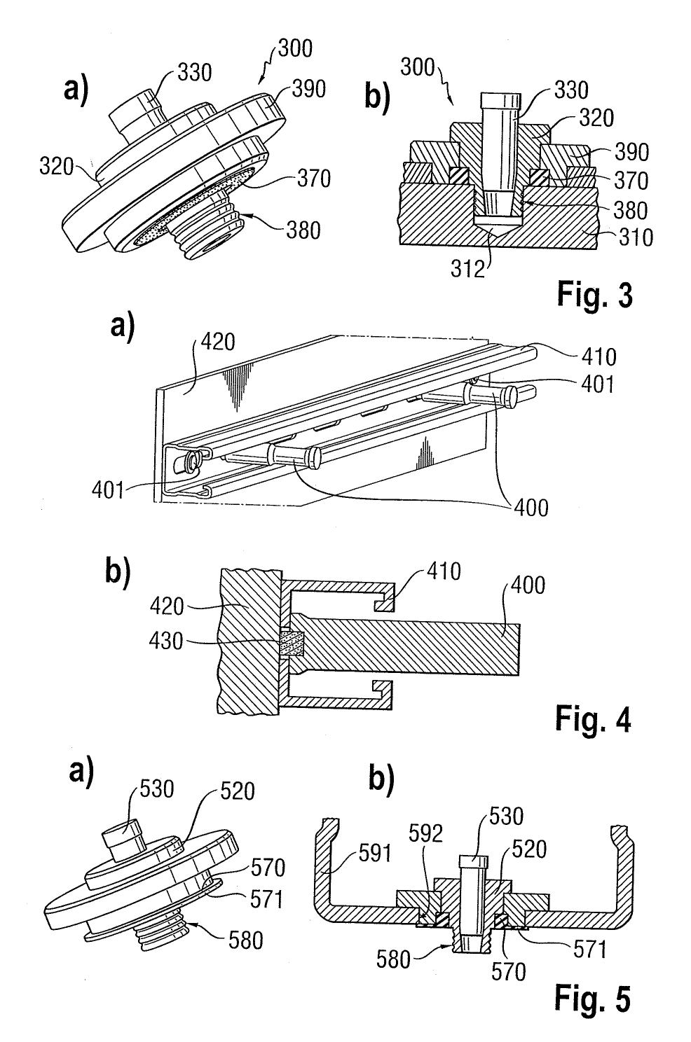

FIG. 3 shows a fastening device,

FIG. 4 shows an auxiliary tool,

FIG. 5 shows a fastening device,

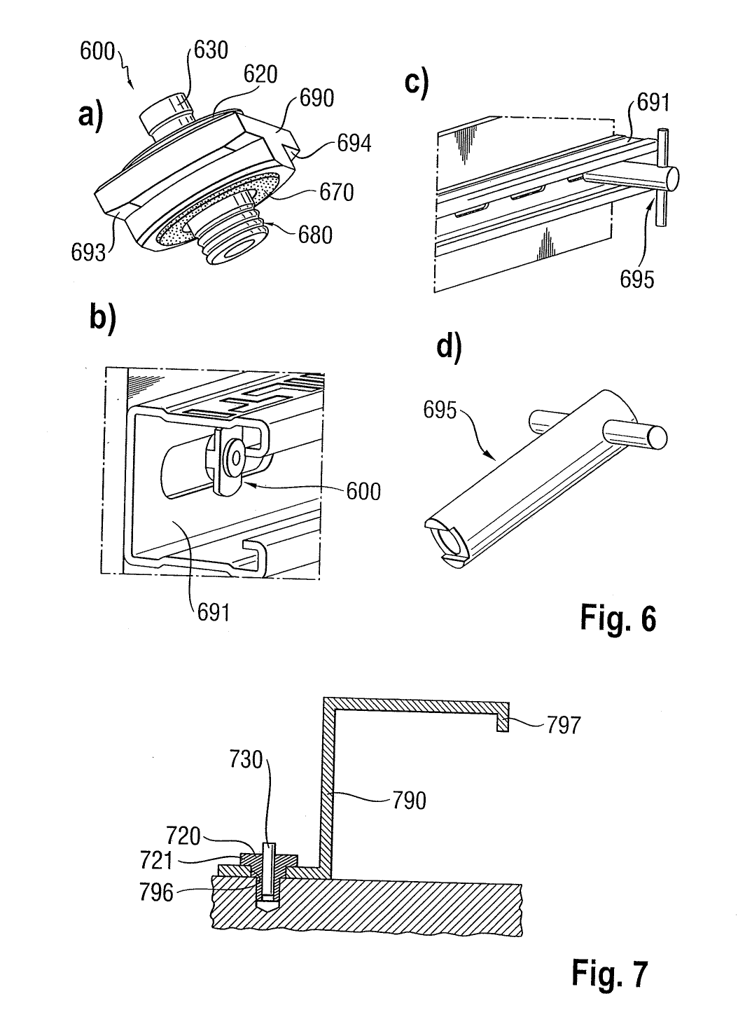

FIG. 6 shows a fastening device and an auxiliary tool,

FIG. 7 shows a fastening device in cross section,

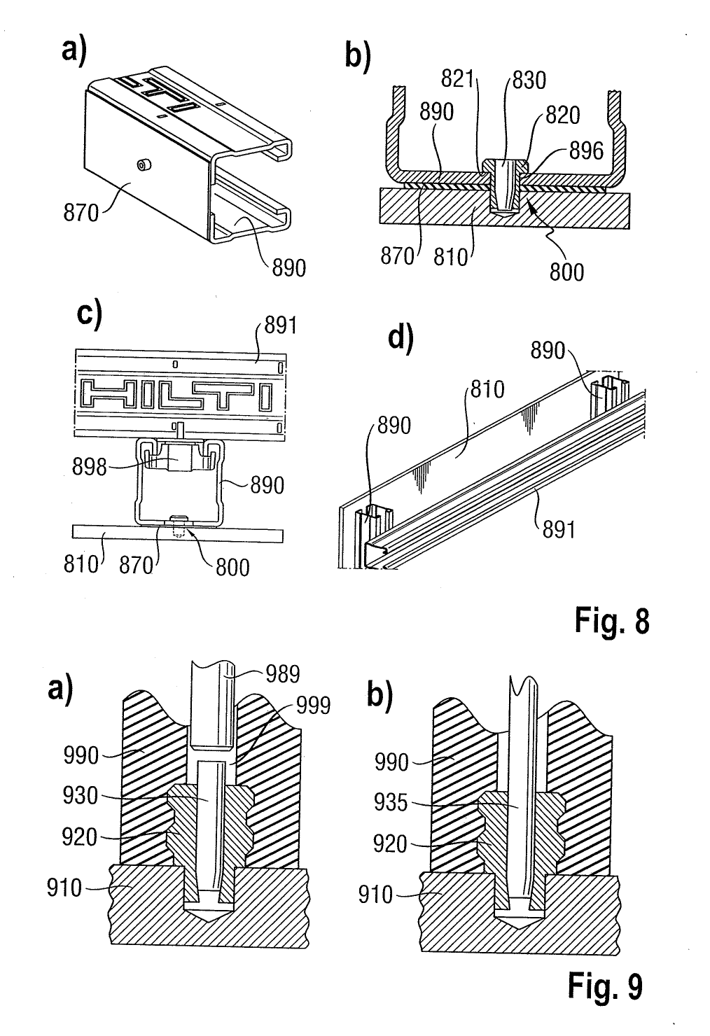

FIG. 8 shows a fastening device,

FIG. 9 shows a fastening device in cross section,

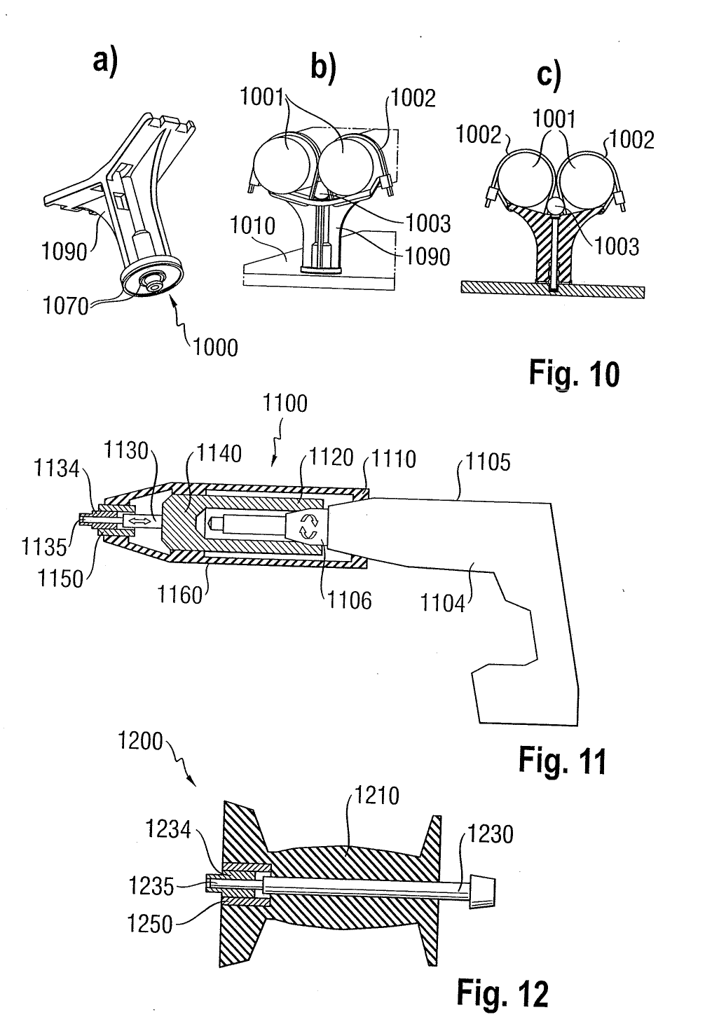

FIG. 10 shows a fastening device,

FIG. 11 shows a percussion device in cross section, and

FIG. 12 shows a percussion device in cross section.

FIG. 1 shows a fastening device 100 for fastening a not-shown first object on a second object 110. The fastening device 100 features a sleeve 120 and an arbor 130, wherein the sleeve features a first load application means 121 for the first object and an abutment 140 for an outer surface 111 of the second object, as well as a passage 150, wherein the passage 150 features an insertion section 151 that lies adjacent to the first load application means 121 and an expansion section 152, and wherein the expansion section 152 features a contraction 160 that is smaller than the outside dimensions of the arbor. The arbor 130 can be inserted into the insertion section in a freely movable fashion. A sealing element 170 seals the sleeve 120 relative to the second object 110 so as to protect the drilled hole 112 in the second object 110 from intruding media and, in particular, from corrosion.

According to a method for fastening the not-shown first object on the second object 110, the second object 110 is initially provided with the drilled hole 112. The sleeve 120 is then inserted into the drilled hole 112. The arbor 130 is subsequently driven into the insertion section 151 (FIG. 1a) and then into the expansion section 152 (FIG. 1b) along the arrow 174. According to one particularly preferred embodiment, the fastening device is already supplied with the arbor fitted into the insertion section. When the arbor is driven into the sleeve, the region of the sleeve 120 that is inserted into the drilled hole 112 is expanded against the drilled hole in the direction of the arrows 175.

FIG. 2a shows a detail of a sleeve 220 of a fastening device 200, in which the contraction 260 extends beyond the point of the passage 250 that is the closest adjacent point to the abutment 240. Consequently, the entire drilled hole in the second object, particularly also the wall of the drilled hole near the surface, is used for producing a press fit. The sleeve 220 furthermore features a second load application means 280 for the second object adjacent to the expansion section. The load application means 280 features grooves 281 and preferably circumferential and, in particular, flattened projections 282 in order to achieve an improved clamping effect and/or positive fastening of the sleeve 220 in the drilled hole. The contraction 260 increasingly contracts the passage 250 from the point of the passage 250 that is the closest adjacent point to the abutment 240 to the second load application means 280 and features a cylindrical section 261. An arbor 230 is illustrated in its end position so that it is clear that the inside dimensions of the contraction 260 are smaller than the outside dimensions of the arbor 230.

FIG. 2b shows a detail of a sleeve 225 of a fastening device 205, in which the contraction 265 extends beyond the point of the passage 255 that is the closest adjacent point to the abutment 245. The sleeve 225 furthermore features a second load application means 285 for the second object adjacent to the expansion section. The contraction 265 increasingly contracts the passage 255 from the point of the passage 255 that is the closest adjacent point to the abutment 245 to the second load application means 285 and features a conical section 262. An arbor 235 is illustrated in its end position so that it is clear that the inside dimensions of the contraction 265 are smaller than the outside dimensions of the arbor 235.

FIG. 3 shows a fastening device 300. In addition to a sleeve 320, an arbor 330, a sealing element 370 and a second load application means 380 for the anchoring in a drilled hole 312 in the second object 310, the fastening device 300 also features a holding element 390. The holding element 390 is supported on a shoulder 321 of the sleeve 320 and therefore positively fixed on the sleeve 320.

FIG. 4 shows an auxiliary tool 400 that serves for temporarily holding a rail 410 on a surface 420. For this purpose, one or more longitudinal slots of the rail 410 are aligned with previously produced drilled holes and held with the auxiliary tools 400. The auxiliary tool 400 features a magnet 430 for applications on steel or other ferromagnetic surfaces. The fastening devices 401 are subsequently anchored in the drilled holes and the auxiliary tools are removed.

FIG. 5 shows a fastening device 500. In addition to a sleeve 520, an arbor 530 and a second load application means 580, the fastening device 500 features a sealing element 570 with a circumferential lip 571. The lip 571 initially serves for positively holding the fastening device 500 in a hole or slot 592 of a fastening element, for example, a rail 591. For this purpose, the fastening element 500 is completely inserted into the slot 592 in such a way that the lip 571 snaps into the slot 592. The fastening element 500 then preferably can still be displaced along the slot 592. Subsequently, the fastening element 500 with the preassembled rail 591 is inserted into a pre-drilled blind hole in the surface. The arbor 530 is then driven in such that the sleeve 520 radially expands and the rail 591 is fastened. In addition to the sealing effect of the sealing element 570 between the surface and the sleeve 520, the lip 571 now acts as a seal between the rail 591 and the surface.

FIG. 6 shows a fastening device 600. In addition to a sleeve 620, an arbor 630, a sealing element 670 and a second load application means 680, the fastening device 600 also features a holding element 690. The holding element 690 is supported in a freely rotatable fashion on a not-shown shoulder of the sleeve 620 and therefore positively fixed on the sleeve 620. The holding element 690 has an asymmetric cross section perpendicular to a longitudinal axis of the sleeve 620. The holding element 690 features, in particular, two hold-down implements 693, 694 that protrude from the holding element in two opposite directions perpendicular to the longitudinal axis of the sleeve 620.

The fastening element 600 is initially anchored in the surface. A rail 691 with a longitudinal slot is then aligned with the hold-down implements 693, 694 and threaded into the fastening element 600. The holding element 690 is turned by approximately 90° with an auxiliary tool 695 such as, for example, an open-end wrench or socket wrench such that the rail 691 is positively fastened on the surface with the aid of the hold-down implements 693, 694. In order to prevent the hold-down implements 693, 694 from turning back, it is particularly preferred to provide a catch between the fastening element 600 and the rail 691. The catch features, for example, a tab on the fastening element and a groove in the rail.

FIG. 7 shows a fastening device 700 that features a sleeve 720, an arbor 730 and a holding element 790. An opening 796 of the holding element 790 is supported on a shoulder 721 of the sleeve 720 such that the holding element is positively fixed on the sleeve 720. The holding element 790 is realized in the form of a bracket and serves, for example, for holding a not-shown rail that is prevented from sliding out by means of a projection 797 of the holding element 790.

FIG. 8 shows a fastening device 800 that features a sleeve 820, an arbor 830 and a holding element 890. An opening 896 of the holding element 890 is supported on a shoulder 821 of the sleeve 820 such that the holding element is positively fixed on the sleeve 820. The holding element 890 is realized in the form of a rail and serves, for example, for holding another rail 891 that is fastened on the holding element 890 by means of a holder 898. The holding element 890 features a sealing element 870 for realizing a seal between the holding element 890 and a surface 810.

FIG. 9 shows a fastening device 900 in cross section that features a sleeve 920, an arbor 930 and a holding element 990 for the anchoring on a surface 910. The holding element 990 is made of plastic and injection-molded onto the sleeve 920 such that it is integrally fixed on the sleeve 920. In a holding element that protrudes past the sleeve in the direction opposite the fastening direction, the arbor 930 is driven into the sleeve 920 by means of a driving tool 989 that plunges into a recess 999 of the holding element 990 (FIG. 9a) or with the aid of an elongated arbor 935 that protrudes past the holding element (FIG. 9b).

FIG. 10 shows a fastening device 1000 with a holding element 1090 of plastic injection-molded thereon. The holding element 1090 serves, for example, for holding cables 1001 at a desired distance from a surface 1010. For this purpose, the holding element 1090 features two cable ties 1002 that are preferably fastened on the holding element 1090 (FIG. 10b) or injection-molded on the holding element 1090 (FIG. 10c). A holding rod 1003 serves for supporting the cables 1001 against sagging. The fastening device furthermore features one or more sealing rings 1070 for realizing a seal between the holding element 1090 and the surface 1010.

FIG. 11 shows a percussion device 1100. The percussion device 1100 features a supporting means 1110 for supporting the percussion device 1100 on a housing 1105 of a drill 1104 in a rotationally rigid fashion, a power take-off means 1120 for tapping a rotational movement of a rotatively driven drill chuck 1106 of the drill 1104, a striking element 1130 for transmitting percussions to an arbor 1135 of a fastening element 1134 and a striking mechanism 1140 for converting a rotational movement of the power take-off means 1120 into a linear movement of the striking element 1130. The striking mechanism 1140 is preferably realized in the form of a spring-cam striking mechanism. The percussion device 1100 furthermore features a housing 1160 with a receptacle 1150 for the fastening element 1134. The rotationally rigid support of the percussion device 110 on the housing 1105 of the drill 1104 is preferably realized with a bayonet coupling between the supporting means 1110 and the housing 1105. The percussion device 1100 also features a step-down gear that is connected to the power take-off means on the input side and to the striking mechanism on the output side.

The percussion device 1100 makes it possible to use a single drill 1104 for drilling a hole and for driving the arbor into the sleeve. For this purpose, the drill 1104 that preferably consists of a battery-operated electric drill or screwdriver without percussion function is initially fitted with a stop bit and a drilled hole is produced in a surface. Subsequently, the percussion device 1100 is installed on the drill 1104 over the stop bit and an inventive fastening element is inserted into the receptacle 1150 and then anchored in the surface by means of the striking element 1130 that drives the arbor 1135 into the sleeve of the fastening element 1134. In this case, the impact energy is not necessarily so high that the arbor can be driven in with a single strike. On the contrary, it is preferred to drive in the arbor with several strikes that are successively carried out within short time intervals. The desired striking frequency and impact energy is defined with the aid of the step-down gear.

The dimensions of the striking mechanism and of the fastening elements are preferably adapted to one another in such a way that the striking element cannot strike the sleeve, but rather stops a short distance before reaching the sleeve such that the arbor is always driven in to a desired depth without subjecting the sleeve to mechanical stress or damage.

In fastening devices with sealing elements, it is preferred to press the sleeve against the surface with a predetermined force while the arbor is driven in. This is preferably achieved in that the striking mechanism features a force detecting means for detecting a contact force of the fastening element on a surface, as well as coupling means that disengage the power transmission from the power take-off means to the striking element as long as the contact force of the fastening element on the surface is lower than a predetermined force and engage the power transmission from the power take-off means to the striking element when the contact force of the fastening element on the surface is at least as high as the predetermined force. Consequently, the striking movement is only carried out once the contact force reaches the predetermined force. The predetermined force is preferably a force at which the sealing element develops its sealing effect.

FIG. 12 shows a manual percussion device 1200 with a handle 1210, a striking element 1230 and a receptacle 1250. A fastening element 1234 with an arbor 1235 can be inserted into the receptacle 1250.

In not-shown embodiments, a percussion drill, in which the rotary function is switched off, or a setting device operated with gas, powder, compressed air or batteries is used for driving in the arbor.

The invention was described with reference to examples of a device for fastening a first object on a second object and a corresponding fastening method. In this case, the characteristics of the described embodiments also can be arbitrarily combined with one another within a single fastening device or a single fastening method. It should furthermore be noted that the inventive devices and the inventive method are also suitable for other purposes.

1. A device for fastening a first object on a second object, comprising a sleeve and an arbor, wherein the sleeve comprises a first load application means for the first object and an abutment for an outer surface of the second object, the sleeve further comprising a passage, wherein the passage comprises an insertion section that lies adjacent to the first load application means and an expansion section, wherein the expansion section comprises a contraction that is smaller than the outside dimensions of the arbor, and wherein the contraction extends at least up to a point of the passage that is the closest adjacent point to the abutment.

2. The device according to claim 1, wherein the contraction increasingly contracts the passage from the point of the passage that is the closest adjacent point to the abutment to the second load application means.

3. The device according to claim 2, wherein the contraction comprises a conical section.

4. The device according to claim 1, wherein the contraction comprises a cylindrical section.

5. The device according to Claim 1, wherein the arbor can be inserted into the insertion section in a freely movable fashion.

6. The device according to claim 1, wherein the sleeve comprises a second load application means for the second object adjacent to the expansion section.

7. The device according to claim 1, wherein the device comprises a sealing element for realizing a seal between the sleeve and the second object.

8. The device according to claim 1, wherein the first load application means comprises a holding element that is positively and/or integrally fixed on the sleeve.

9. The device according to claim 8, wherein the holding element is arranged such that it is freely rotatable about an axis relative to the sleeve and realized such that it has an asymmetric cross section perpendicular to said axis.

10. A method for fastening a first object on a second object, comprising a) providing the second object with a recess, b) inserting into the recess a sleeve with comprising a first load application means for the first object, the sleeve also comprising an abutment for an outer surface of the second object, and a passage, wherein the passage comprises an insertion section that lies adjacent to the first load application means and an expansion section, c) inserting an arbor into the insertion section, wherein the expansion section comprises a contraction that is smaller than the outside dimensions of the arbor, and d) driving the arbor into the expansion section such that the region of the sleeve inserted into the recess is expanded against the recess.

11. The method according to claim 10, wherein a) and d) are carried out with the same tool.

12. A device for generating percussions on a fastening element, comprising a supporting means for supporting the device on a housing of a drill in a rotationally rigid fashion, a power take-off means for tapping a rotational movement of a rotatively driven drill chuck of the drill, a striking element for transmitting percussions to the fastening element, and a striking mechanism for converting a rotational movement of the power take-off means into a linear movement of the striking element.

13. The device according to claim 12, wherein the device comprises, a step-down gear connected to the power take-off means on the input side and to the striking mechanism on the output side.

14. The device according to claim 12, wherein the device comprises a receptacle for the fastening element.

15. The device according to claim 12, wherein the striking mechanism comprises a force detecting means for detecting a contact force of the fastening element on a surface, as well as coupling means that disengage the power transmission from the power take-off means to the striking element as long as the contact force of the fastening element on the surface is lower than a predetermined force and engage the power transmission from the power take-off means to the striking element when the contact force of the fastening element on the surface is at least as high as the predetermined force.

16. The device according to claim 13, wherein the device comprises a receptacle for the fastening element.

17. The device according to claim 13, wherein the striking mechanism comprises a force detecting means for detecting a contact force of the fastening element on a surface, as well as coupling means that disengage the power transmission from the power take-off means to the striking element as long as the contact force of the fastening element on the surface is lower than a predetermined force and engage the power transmission from the power take-off means to the striking element when the contact force of the fastening element on the surface is at least as high as the predetermined force.

18. The device according to claim 14, wherein the striking mechanism comprises a force detecting means for detecting a contact force of the fastening element on a surface, as well as coupling means that disengage the power transmission from the power take-off means to the striking element as long as the contact force of the fastening element on the surface is lower than a predetermined force and engage the power transmission from the power take-off means to the striking element when the contact force of the fastening element on the surface is at least as high as the predetermined force.

19. The device according to claim 2, wherein the arbor can be inserted into the insertion section in a freely movable fashion.

20. The device according to claim 2, wherein the sleeve comprises a second load application means for the second object adjacent to the expansion section.
